(19) United States
(12) Patent Application Publication
(10) Pub. No.: US 2010/0131641 A1
(43) Pub. Date: May 27, 2010

(54) SYSTEM AND METHOD FOR IMPLEMENTING A WIRELESS QUERY AND DISPLAY INTERFACE

(75) Inventors: Jeremy Ray Brown, Orem, UT (US); Jason Allen Sabin, Lehi, UT (US); Daniel Robert Timpson, Lehi, UT (US)

Correspondence Address: HAYNES AND BOONE, LLP;IP Section, 2323 Victory Avenue, Suite 700, Dallas, TX, 75219, US

(73) Assignee: NOVELL, INC., Provo, UT (US)

(21) Appl. No.: 12/324,183

(22) Filed: Nov. 26, 2008

(51) Int. Cl. G06F 15/16

(52) U.S. Cl. 709/224

(57) ABSTRACT

System and method for implementing a wireless query and display interface are disclosed. In one embodiment, the system includes a machine to be monitored and an end-point associated with the machine and comprising an interface, the end-point for connecting to the machine to be monitored via the interface. The system further includes a consolidator comprising an identity service and a Global Device Identity Listing (“GDIL”), the GDIL for maintaining a list of machines to be monitored using the system and a wireless device for viewing the list maintained by the GDIL and for issuing commands and queries related to one or more of the machines on the list. The end-point, the consolidator, and the wireless device are capable of wirelessly communicating with one another.

### BACKGROUND

Data centers and computer laboratories (hereinafter collectively referred to as “labs”) by their nature generally include a number of individual machines, such as servers, computers, printers, and other devices, some or all of which are typically interconnected via one or more networks. One critical element of managing such environments is to have the ability to query machines within the lab to identify failing or failed hardware, a particular machine, a networking error, or other condition, such as a software error. Clearly, the sheer number of the machines in such environments make it difficult to do so. Currently, a machine must be in a working state and connected to the network in order to gather information therefrom. Therefore, it would be advantageous to provide a separate device that is dependent on neither the operating system of the machine nor any network connections with which the display of the machine can be viewed.

### SUMMARY

One embodiment is a system for implementing a wireless query and display interface. The system includes a machine to be monitored and an end-point associated with the machine and comprising an interface, the end-point for connecting to the machine to be monitored via the interface. The system further includes a consolidator comprising an identity service and a Global Device Identity Listing (“GDIL”), the GDIL for maintaining a list of machines to be monitored using the system and a wireless device for viewing the list maintained by the GDIL and for issuing commands and queries related to one or more of the machines on the list. The end-point, the consolidator, and the wireless device are capable of wirelessly communicating with one another.

### BRIEF DESCRIPTION OF THE DRAWINGS

FIG. 1 is a block diagram of a system in which a wireless query and display interface of one embodiment may be advantageously implemented.

FIG. 2 is a flow diagram of the operation of the system of FIG. 1 for implementing a wireless query and display interface of one embodiment.

### DETAILED DESCRIPTION

To better illustrate the advantages and features of the embodiments, a particular description of several embodiments will be provided with reference to the attached drawings. These drawings, and other embodiments described herein, only illustrate selected aspects of the embodiments and are not intended to limit the scope thereof. Further, despite reference to specific features illustrated in the example embodiments, it will nevertheless be understood that these features are not essential to all embodiments and no limitation of the scope thereof is thereby intended. Any alterations and further modifications in the described embodiments, and any further applications of the principles of the embodiments as described herein are contemplated as would normally occur to one skilled in the art. Furthermore, some items are shown in a simplified form, and inherently include components that are well known in the art. Further still, some items are illustrated as being in direct connection for the sake of simplicity and clarity. Despite the apparent direct connection, it is understood that such simplicity and clarity. Despite the apparent direct connection, it is understood that such illustration does not preclude the existence of intermediate components not otherwise illustrated.

As will be explained, the embodiments described herein harness the power of queries and combines that power with a secure wireless interface and a small human-readable display. This strong combination provides queries with seamless networking and a visual display to locate a machine or set of machines within a lab environment based on specified criteria. As will be further explained, an exemplary use of the embodiments described herein is as follows. For example, assuming an engineer needs to find locate all machines in a lab that are not “listening” on a network that are receiving hardware errors to run a diagnostics, the embodiments described herein allow the engineer first to build a query to identify the machines with errors and that cannot “ping” a working server. Once the query has executed, the display associated with each such identified machine will provide a visual indication, such as a flashing red light or an error message, thus enabling a technician to determine where the error is occurring, as well as why it may be occurring (such as due to a router or bad cooling). Additionally, the affected machine(s) may be rebooted based upon the query and the results.

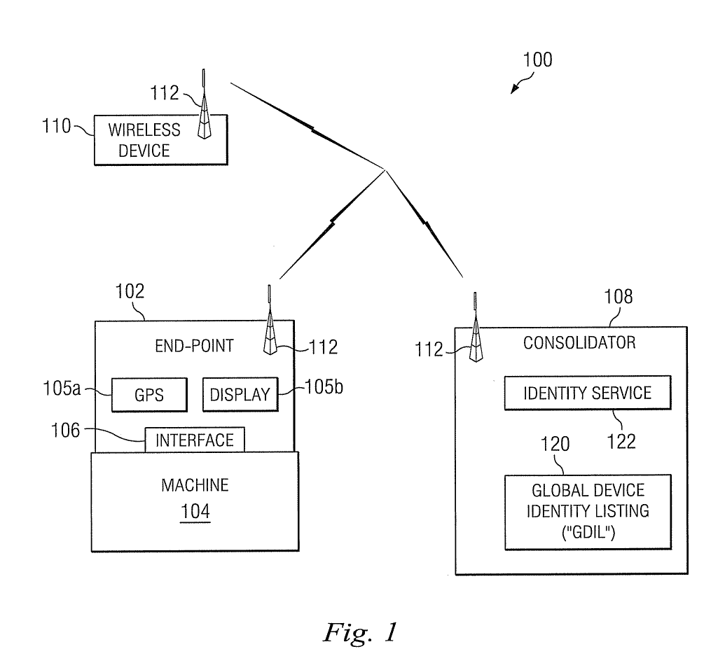

FIG. 1 is a block diagram of a system 100 in which a wireless query and display interface of one embodiment may be advantageously implemented. As shown in FIG. 1, the system 100 includes an end-point 102 which is connected to and interacts with a machine to be monitored, such as a machine 104, via a physical interface 106 in a manner to be described in detail hereinbelow. In one embodiment, the end-point 102 includes a location finding device, which is illustrated in FIG. 1 and described herein as comprising a global positioning system (“GPS”) but may comprise any other means of determining a location of the end-point, designated by a reference number 105a and a human-readable display 105b. The human-readable display 105a may be a small LCD screen or other type of display capable of displaying actual data to enable a user to locate a specific box, as will be described.

The machine 104 may be one of any number of different types of electronic devices, including but not limited to a server, a cash register, a switch, or a printer. In one embodiment, the machine 104 is one of several machines (not shown) located in one or more computer labs and which machines may be interconnected via a conventional network. The interface 106 is designed to be connected to the machine via any connection that allows for power and interface options, such as, for example, a USB port. Additionally, as will be described in greater detail below, during setup of the system 100, the end-point 102 is physically connected to a consolidator 108 via the interface 106 to enable the consolidator to create a unique identity for the end-point 102 and create a certificate based on the identity. It will be recognized that, in operation, a number of networked machines, such as the machine 104, and associated end-points 102 will be provided and that a single machine and end-point are illustrated in FIG. 1 only for purposes of clarity.

A monitoring device 110, which may comprise one of any number of appropriate wireless devices such as a PDA, mobile phone, or a laptop computer device, provides wireless query and display interface capabilities in connection with the system 100 in accordance with one embodiment, as will be described in greater detail below. The wireless device 110, consolidator 108, and end-point 102 communicate via wireless connection, as represented in FIG. 1 by antennas 112. It should be noted that although the device 110 is shown and described as wirelessly communicating with the consolidator 108, it is anticipated that a wired device could also be used, in which case the device could be connected to the consolidator 108 via a wire line connection to achieve the same functionality described herein with respect to a wireless device.

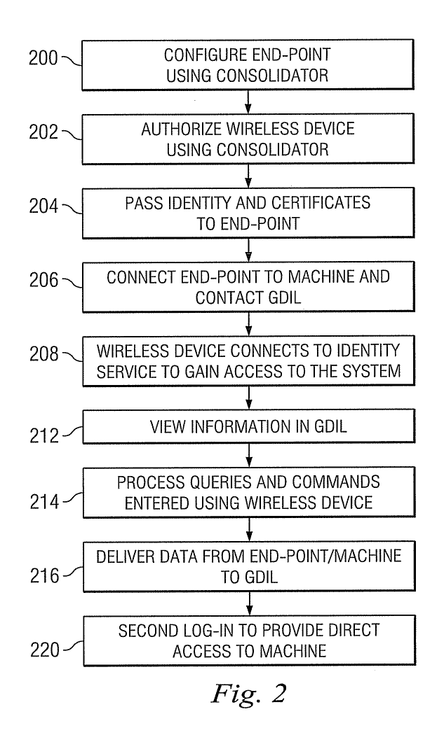

FIG. 2 is a flowchart illustrating operation of the system 100 in accordance with one embodiment. In step 200, during set-up of the system 100, the end-point 102 is configured by physically connecting it to the consolidator 108 via the interface 106. As noted above, the consolidator 108 creates a unique identity for the end-point 102 and creates a certificate based on this identity. In step 202, also during set-up of the system 100, the monitoring device 110 is authorized by the consolidator 108 via a wired connection or local access on the device 110, thus eliminating the inconvenience of entering a password or key for the monitoring device and allowing access into the system 100 from any type of monitoring device into the network. The fact that the authorization is performed via a physical connection between the device 110 and the consolidator 108 provides additional security.

Upon completion of the authorization in step 202 and also during set-up, in step 204, the identity and certificates are passed to the end-point 102. There are multiple certificates based upon the requirements of the system 100 with shared keys and certificates through it. The certificate establishes a shared trust by actually connecting through physical connection and sets up the use of identity to grant secure access at a later time. Step 206 is initiated when the end-point 102 is physically connected to the machine 104. In particular, when the connection is made and the machine 104 is powered on, it immediately contacts a Global Device Identity Listing (“GDIL”) 120 (FIG. 1) maintained within the consolidator 108. The GDIL puts all of the machines within the system 100, such as the machine 104, into one category to build the settings that connect them into a seamless network. This step requires no configuration. It will be noted that the interface 106 is capable of sending keyboard commands and display the machine's image to the monitoring device 110 over the wireless network. The interface 106 can also work with additional adapters, as will be described below. The interface 106 is capable of working with the system 100 through various different stages of BIOS, start-up, and OS; therefore, there will be at least a command line interface/command prompt interface/GUI for any machine to which it is connected. One embodiment employs those interfaces through USB ports, COM ports, proprietary ports to interact with the machines.

In step 208, the monitoring device 110 connects to an identity service 122 (FIG. 1) of the consolidator 108 to gain access to the system 100. As previously noted, the monitoring device 110 may be one of any number of different types of devices, such as a mobile phone, PDA, portable computer, or any other device that can communicate wirelessly (or via a wire line connection, in the case of a wired monitoring device) and has an interface. Step 208 provides authentication against the identity service 122 to setup the protection and access control for the embodiments described herein. In step 210, all of the machines that have been configured are reflected in the GDIL120. At this point, a user can use the monitoring device 110 as an interface to view the configured machines and query the necessary information. It will be noted that this is the primary method for running queries to interact with endpoints. In step 212, interface commands input using the monitoring device 110 to be passed to the devices for manipulating the listings in the GDIL 120 are processed. In step 214, commands and instructions entered via the monitoring device 110 are pushed down the end-points to capture all the IP addresses and hostnames for the different machines. The initial setup merely obtains the last settings from the GDIL 120 to show the IP, hostname and OS.

In step 216, data is delivered back to the GDIL120, which is the central location from which a listing of all of the machines may be obtained for display on the monitoring device 110. An advantage to this method is that it can be set up such that it runs even if the machine is powered off so the end-point 102 would have to store the data. In this situation, the interface 106 would have to provide power and then pass back information to the system 100 and even allow the system to start the machine 104. This may be accomplished using a simple power cord adapter that simply controls the power to the machine 104, as described in greater detail below.

In accordance with features of one embodiment additional components may be added to expand the functionality of the end-point 102. For example, addition of a VGA/video adapter would enable a user to plug into the endpoint to provide a display to the commands and users. As the bandwidth for wireless technology is changing drastically, either the full display or a very limited black and white compressed image could be displayed. Addition of a power adapter would provide the ability to turn the power on and off, as well as to power the endpoint. Moreover, control of the mouse/keyboard could be provided, in which case the end-point 102 would be connected to another type of interface.

In step 220, a second log-in occurs to provide direct access to a machine, such as the machine 104. The purpose of step 220 is to have the two features separated so as to avoid opening security holes into the lab. This step is accomplished via the identity service 122, thereby automatically providing advanced methods of security and policies/roles for the administration.

In the illustrated embodiment, a command line interface/command prompt interface/GUI is provided to the user at the monitoring device 110 based on the identity service 122. This enables either direct connection with periodic checks against the identity service or a timeout feature. As a result, the embodiments described herein provide a remote interface to access machines directly without concern for network, OS, or configuration problems. The interface can be made directly via the monitoring device 110. Alternatively, remote access may be provided via a box that functions as a gateway with a monitoring device. The connection can be any service that can be run remotely, as the wireless technology allows incredible functionality.

As previously noted, the end-point 102 includes the display 105b, which in one embodiment is used to provide a visual indication of the identity of the machine 104. For example, assuming a user uses the monitoring device 110 to identify a particular machine having a DHCP address of 192.168.1.194 because it has been compromised. Assuming the machine 104 is the identified machine, the display 105b of the endpoint 102 will display information for enabling the machine to be physically located and identified.

In one embodiment, the system 100 may be used in combination with methodologies such as those described in U.S. patent application Ser. No. 12/171,078 entitled SYSTEM AND METHOD FOR DEVICE MAPPING BASED ON IMAGES AND REFERENCE POINTS. In such an embodiment, a map of the location of each machine within a lab can be built dynamically, after which a command may be transmitted to show the Operating System and version then capture the map. Subsequently, the next command may be changed to display the IP and state of the machine to build a map. At that point, the user can cross-reference the OS with the uptime to determine the state of different machines on a timer to illustrate what is happening in the lab.

As previously noted, the end-point 102 includes a GPS 105a. The GPS 105a enables the end-point 102 to determine and identify a location of the machine 110 buildings, datacenters or offices. Depending on the capabilities of the GPS 105, the location of the machine 110 may be determined with accuracy to within inches of the actual location thereof.

It will be noted that the ability to work with the identity service 122 enables combination of multiple groups of a company into a single system. For example, within a single company, a group would be created for a test lab and the group would connect with the identity service based on roles. Each lab could have a single consolidator to authenticate the machines. The corporate identity service could locate all of the machines and provide a single view to find any particular machine. This solution would provide the company with real control of the networks and what is happening on the machines. It could also be used also as a method to monitor users and could easily be implemented as a secondary monitoring device in a laptop/machine that would allow the same functionality and control.

While the preceding description shows and describes one or more embodiments, it will be understood by those skilled in the art that various changes in form and detail may be made therein without departing from the spirit and scope of the present disclosure. For example, various steps of the described methods may be executed in a different order or executed sequentially, combined, further divided, replaced with alternate steps, or removed entirely. In addition, various functions illustrated in the methods or described elsewhere in the disclosure may be combined to provide additional and/or alternate functions. Therefore, the claims should be interpreted in a broad manner, consistent with the present disclosure.

What is claimed is:

1. A system for providing a wireless query and display interface in a computer environment, the system comprising:
a machine to be monitored;
an end-point associated with the machine and comprising an interface, the end-point for connecting to the machine to be monitored via the interface;
a consolidator comprising an identity service and a Global Device Identity Listing (“GDIL”), the GDIL for maintaining a list of machines to be monitored using the system; and
a wireless device for viewing the list maintained by the GDIL and for issuing commands and queries related to one or more of the machines on the list;
wherein the end-point, the consolidator, and the wireless device are capable of wirelessly communicating with one another.

2. The system of claim 1 wherein the end-point further comprises a location finding system for indicating a location of the end-point.

3. The system of claim 1 wherein the end-point further comprises a visual indicator for indicating a status of the machine based on a query from the wireless device.

4. The system of claim 1 wherein the end-point is connectable to the consolidator for enabling the identity service to create a unique identity for and issue a certificate to the end-point.

5. The system of claim 1 wherein the interface comprises an interface selected from a group consisting of a USB port interface, a COM port interface, and a proprietary interface.

6. The system of claim 1 wherein a temporary physical connection is provided between the wireless device and the consolidator to enable authorization of the wireless device by the identity service.

7. The system of claim 1 further comprising a plurality of machines to be monitored and for each of the machines, an end-point device associated with the machine and comprising an interface, the end-point for connecting to the machine via the interface.

8. A method for providing a wireless query and display interface in a computer environment comprising a plurality of machines to be monitored, the method comprising:
providing for each of the machines an end-point associated with the machine, the end-point comprising an interface such that the end-point is connectable to the machine via the interface;
providing a consolidator comprising an identity service and a Global Device Identity Listing (“GDIL”), the GDIL for maintaining a list of machines to be monitored using the system; and
providing a wireless device for viewing the list maintained by the GDIL and for issuing commands and queries related to one or more of the machines on the list;
wherein the end-point, the consolidator, and the wireless device are capable of wirelessly communicating with one another.

9. The method of claim 8 wherein the end-point further comprises a location finding system for indicating a location of the end-point.

10. The method of claim 8 wherein the end-point further comprises a visual indicator for indicating a status of the machine based on a query from the wireless device.

11. The method of claim 8 further comprising connecting the end-point to the consolidator for enabling the identity service to create a unique identity for and issue a certificate to the end-point.

12. The method of claim 8 wherein the interface comprises an interface selected from a group consisting of a USB port interface, a COM port interface, and a proprietary interface.

13. The method of claim 8 further comprising providing a temporary physical connection between the wireless device and the consolidator to enable authorization of the wireless device by the identity service.

14. A system for providing a wireless query and display interface in a computer environment, the system comprising:
a machine to be monitored;
an end-point associated with the machine and comprising an interface, the end-point for connecting to the machine to be monitored via the interface;
a consolidator comprising an identity service and a Global Device Identity Listing (“GDIL”), the GDIL for maintaining a list of machines to be monitored using the system; and
a monitoring device for viewing the list maintained by the GDIL and for issuing commands and queries related to one or more of the machines on the list;
wherein the end-point and the consolidator are capable of wirelessly communicating with one another.

15. The system of claim 14 wherein the end-point further comprises a location finding system for determining a location of the end-point.

16. The system of claim 14 wherein the end-point further comprises a visual indicator for indicating a status of the machine based on a query from the monitoring device.

17. The system of claim 14 wherein the end-point is connectable to the consolidator for enabling the identity service to create a unique identity for and issue a certificate to the end-point.

18. The system of claim 14 wherein the interface comprises an interface selected from a group consisting of a USB port interface, a COM port interface, and a proprietary interface.

19. The system of claim 14 wherein the monitoring device communicates with the consolidator via a wireless connection.

20. The system of claim 14 wherein the monitoring device communicates with the consolidator via wire line connection.
